(19) United States
(12) Patent Application Publication
(10) Pub. No.: US 2025/0168721 A1
(43) Pub. Date: May 22, 2025

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Lin LIANG, Beijing (CN); Gang WANG, Beijing (CN)

(73) Assignee: NEC CORPORATION, Tokyo (JP)

(21) Appl. No.: 18/729,620

(22) PCT Filed: Jan. 26, 2022
(86) PCT No.: PCT/CN2022/074098

§ 371 Date: Jul. 17, 2024

(51) Int. Cl. H04W 36/00; H04W 36/36

(52) U.S. Cl. CPC H04W 36/0069; H04W 36/362

(57) ABSTRACT

Embodiments of the present disclosure relate to methods, devices and computer readable media for communication. A terminal device receives, from a first network device, a conditional reconfiguration for a set of candidate cells, the conditional reconfiguration comprising information indicating that a subsequent conditional cell change is enabled for at least one candidate cell in the set of candidate cells. If a cell change or addition is performed based on the conditional reconfiguration, the terminal device maintains at least a portion of the conditional reconfiguration for use in the subsequent conditional cell change. In this way, a procedure of a subsequent conditional cell change may be enabled.

### TECHNICAL FIELD

Embodiments of the present disclosure generally relate to the field of telecommunication, and in particular, to methods, devices and computer storage media of communication for a conditional cell change.

### BACKGROUND

For a conditional primary secondary cell (PSCell) change (CPC)/conditional PSCell addition (CPA) in third generation partnership project (3GPP) Release 17, a CPC/CPA-configured terminal device has to release a CPC/CPA configuration when completing random access towards a target PSCell. Hence the terminal device has no chance to perform subsequent CPC/CPA without prior CPC/CPA reconfiguration and re-initialization from the network side. This will increase a delay for a cell change and increase signaling overhead, especially in the case of frequent secondary cell group (SCG) changes when operating in frequency range 2 (FR2). Therefore, multi-random access technology dual connectivity (MR-DC) with selective activation of cell groups aims at enabling subsequent CPC/CPA after SCG change, without reconfiguration and re-initialization on a CPC/CPA preparation from the network side. This results in a reduction of signaling overhead and an interrupting time for SCG change. However, a mechanism and a procedure of a subsequent CPC are still incomplete and need to be further developed.

### SUMMARY

In general, embodiments of the present disclosure provide methods, devices and computer storage media of communication for a subsequent conditional cell change.

In a first aspect, there is provided a method of communication. The method comprises: receiving, at a terminal device and from a first network device, a conditional reconfiguration for a set of candidate cells, the conditional reconfiguration comprising information indicating that a subsequent conditional cell change is enabled for at least one candidate cell in the set of candidate cells; and in accordance with a determination that a cell change or addition is performed, maintaining at least a portion of the conditional reconfiguration for use in the subsequent conditional cell change.

In a second aspect, there is provided a method of communication. The method comprises: transmitting, at a first network device and to a terminal device, a conditional reconfiguration for a set of candidate cells, the conditional reconfiguration comprising information indicating that a subsequent conditional cell change is enabled for at least one candidate cell in the set of candidate cells.

In a third aspect, there is provided a method of communication. The method comprises: receiving, at a second network device and from a first network device, a request for resource allocation, the request comprising information indicating that a subsequent conditional cell change is enabled for at least one candidate cell in a set of candidate cells; and transmitting, to the first network device, an acknowledgement for the enabling of the subsequent conditional cell change and a data forwarding address associated with the second network device.

In a fourth aspect, there is provided a method of communication. The method comprises: receiving, at a third network device and from a first network device, a message comprising information indicating that a subsequent conditional cell change is enabled for at least one candidate cell in a set of candidate cells; and transmitting, to the first network device, an acknowledgement for the enabling of the subsequent conditional cell change.

In a fifth aspect, there is provided a method of communication. The method comprises: transmitting, at a third network device and to a first network device, a request for a conditional cell change, the request comprising at least one of a data forwarding address associated with the third network device or information indicating that a subsequent conditional cell change is enabled for at least one candidate cell in a set of candidate cells.

In a sixth aspect, there is provided a terminal device. The terminal device comprises a processor configured to cause the terminal device to perform the method according to the first aspect of the present disclosure.

In a seventh aspect, there is provided a network device. The network device comprises a processor configured to cause the network device to perform the method according to any of the second to fifth aspects of the present disclosure.

In an eighth aspect, there is provided a computer readable medium having instructions stored thereon. The instructions, when executed on at least one processor, cause the at least one processor to perform the method according to the first aspect of the present disclosure.

In a ninth aspect, there is provided a computer readable medium having instructions stored thereon. The instructions, when executed on at least one processor, cause the at least one processor to perform the method according to any of the second to fifth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating an example process of CPA with a subsequent CPC according to embodiments of the present disclosure;

FIG. 3 illustrates a schematic diagram illustrating an example process of a master node (MN) initiated CPC with a subsequent CPC according to embodiments of the present disclosure;

FIG. 4 illustrates a schematic diagram illustrating an example process of a secondary node (SN) initiated CPC with a subsequent CPC according to embodiments of the present disclosure;

FIG. 5 illustrates a schematic diagram illustrating an example process of a subsequent CPC according to embodiments of the present disclosure;

FIG. 6 illustrates an example method of communication implemented at a terminal device in accordance with some embodiments of the present disclosure;

FIG. 7 illustrates an example method of communication implemented at a first network device in accordance with some embodiments of the present disclosure;

FIG. 8 illustrates an example method of communication implemented at a second network device in accordance with some embodiments of the present disclosure;

FIG. 9 illustrates an example method of communication implemented at a third network device in accordance with some embodiments of the present disclosure;

FIG. 10 illustrates another example method of communication implemented at a third network device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “a cell change or addition” may be interchangeably used with “reconfiguration WithSync for SCG or master cell group (MCG)”. In the context of the present application, the term “PSCell” refers to a SpCell of a SCG, the term “PCell” refers to a SpCell of a MCG, and the term “SpCell” refers to a primary cell of a SCG or MCG.

As mentioned above, a mechanism and a procedure of a subsequent CPC are still incomplete and need to be further developed. In view of this, embodiments of the present disclosure provide a solution for enabling a subsequent conditional cell change. In the solution, a conditional reconfiguration is caused to comprise information indicating that a subsequent conditional cell change is enabled for at least one candidate cell in the set of candidate cells, and when a cell change or addition is performed, at least a portion of the conditional reconfiguration is maintained for the at least one candidate cell. In this way, an enabling of a subsequent conditional cell change can be achieved in an efficient and flexible way. Principles and implementations of the present disclosure will be described in detail below with reference to the figures.

It is to be understood that the present solution may be applied in a SCG change, and also may be applied in a MCG change. That is, the present solution may be applied for a subsequent CPC or a subsequent conditional handover. The subsequent CPC or subsequent conditional handover may also be referred to as a selective activation of cell groups, a selective activation of SCGs, a subsequent SCG change, a subsequent cell group change or a subsequent conditional cell change. For convenience, embodiments of the present disclosure will be described by taking a subsequent CPC as an example.

### Example of Communication Network

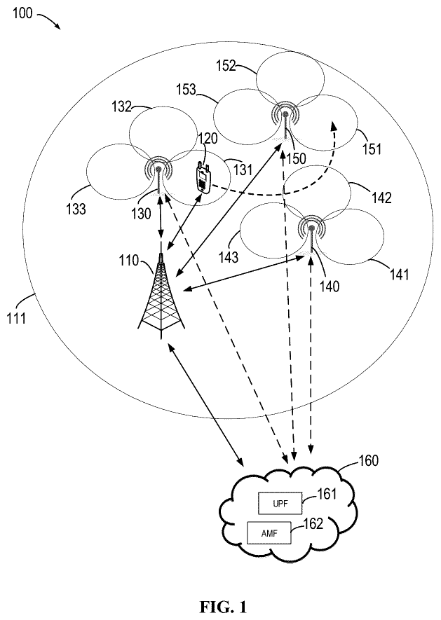

FIG. 1 illustrates a schematic diagram of an example communication environment 100 in which embodiments of the present disclosure can be implemented. As shown in FIG. 1, the communication environment 100 may comprise a network device 110 and a terminal device 120. The network device 110 provides a cell 111 and the terminal device 120 is located in the cell 111 and served by the network device 110.

The communication environment 100 may also comprise one or more other network devices such as network devices 130, 140 and 150. The network device 130 provides cells 131, 132 and 133. The network device 140 provides cells 141, 142 and 143, and the network device 150 provides cells 151, 152 and 153. It should be noted that the number of the cells are not limited to three, and more or less cells are also configured for the terminal device 110.

Assuming that the terminal device 120 may establish a dual connection (i.e., simultaneous connection) with two network devices. For example, the network device 110 may serve as a MN (for convenience, also referred to as MN 110 below), and the network device 130 may serve as a SN (for convenience, also referred to as SN 130 below). Although only the cell 111 is shown, the MN 110 may provide multiple cells, and these cells may form a MCG for the terminal device 120. Assuming that the cell 111 is a primary cell (i.e., PCell) in the MCG. Further, the cells 131, 132 and 133 provided by the network device 130 may form a SCG for the terminal device 120. Assuming that the cell 131 is a primary cell (i.e., PSCell) in the SCG.

The communication environment 100 may also comprise a core network 160. The core network 160 may comprise a user port function (UPF) 161 and an access management function (AMF) 162. It is to be understood that the core network 160 may also comprise any other suitable elements.

The SN 130 may communicate with the terminal device 120 via a channel such as a wireless communication channel. Similarly, the MN 110 may also communicate with the terminal device 120 via a channel such as a wireless communication channel. The SN 130 may communicate with the MN 110 via a control-plane interface such as Xn-C. The MN 110 may communicate with the core network 160 such as the AMF 162 via a control-plane interface such as NG-C. The SN 130 may also communicate with the MN 110 via a user plane interface such as Xn-U, and communicate with the core network 160 such as the UPF 161 via a user plane interface such as NG-U.

It is to be understood that the number of devices or cells in FIG. 1 is given for the purpose of illustration without suggesting any limitations to the present disclosure. The communication environment 100 may involve any suitable number of network devices and/or terminal devices and/or cells adapted for implementing implementations of the present disclosure.

The communications in the communication environment 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the network device 110 may configure a conditional reconfiguration for the terminal device 120.

Assuming that the cells 131-133, 141-143 and 151-153 are configured to the terminal device 110 as candidate cells. In some scenarios, the terminal device 120 may initially communicate with only the network device 110. As the terminal device 120 moves, when a condition for a candidate cell (for example, the cell 131) is fulfilled, the terminal device 120 may be caused to establish the dual connection with the network device 110 and the network device 130. This process of SN addition may be called as a CPA.

In some scenarios, the terminal device 120 may establish a dual connection with the network devices 110 and 130. The network device 110 serves as a MN and the network device 130 serves as a SN. As the terminal device 120 moves, when a condition for another candidate cell (for example, the cell 142) is fulfilled, a SN serving the terminal device 120 may be changed from the network device 130 (also referred to as a source SN or current SN 130) to the network device 140 (also referred to as a target SN 140). This process of PScell change may be called as a CPC. In some scenarios, after the terminal device is configured with conditional reconfiguration and with subsequent CPC being enabled, and before at least one execution condition is fulfilled for any candidate PScell, the terminal device 120 may receive a RRC Reconfiguration message containing reconfiguration WithSync for SCG from the network device 110, and the terminal device 120 may perform a PScell change or addition accordingly. This procedure is called as legacy PScell change or addition. As an example, after the legacy PSCell change or addition procedure, the SN serving the terminal device 120 is the network device 140.

After the above CPA, CPC or legacy PSCell change/addition procedure, as the terminal device 120 further moves, when a condition for still another candidate cell (for example, the cell 152) is fulfilled, a SN serving the terminal device 120 may be changed from the network device 140 to the network device 150 (also referred to as a target SN 150). This process of SN change may be called as a subsequent CPC.

Embodiments of the present disclosure provide a solution for enabling and performing a subsequent conditional cell change such as conditional PSCell or PCell change.

### Example Implementation of Subsequent Conditional Cell Change

In the present solution, a conditional reconfiguration comprises information indicating that a subsequent conditional cell change is enabled for at least one candidate cell in a set of candidate cells. If a cell change or addition is performed, at least a portion of the conditional reconfiguration is maintained for the at least one candidate cell. In this way, an enabling of a subsequent conditional cell change can be achieved in a flexible way. For convenience, more detailed description will be given below by taking a subsequent CPC as an example.

### 1. Example Implementation of CPA With Subsequent CPC

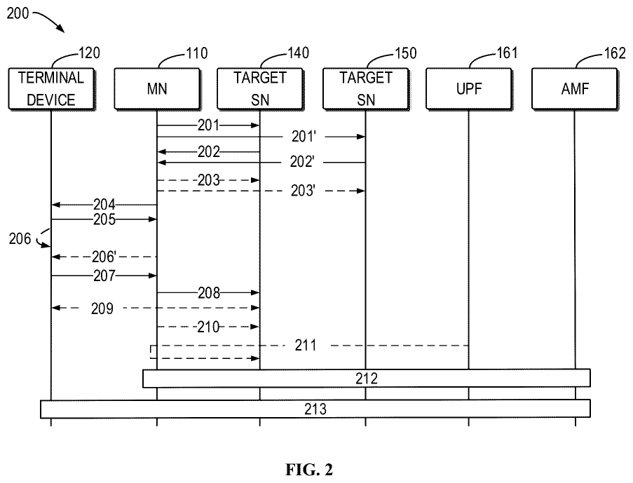

FIG. 2 illustrates a schematic diagram illustrating an example process 200 of CPA with a subsequent CPC according to embodiments of the present disclosure. For the purpose of discussion, the process 200 will be described with reference to FIG. 1. The process 200 may involve the terminal device 120, the network devices 110, 140 and 150, the UPF 161 and the AMF 162 as illustrated in FIG. 1. In this example, the network device 110 is a MN serving the terminal device 110, and the network devices 140 and 150 are potential target SNs serving the terminal device 110.

As shown in FIG. 2, the MN 110 may transmit 201 a request for resource allocation to the target SN 140. The MN 110 may also transmit 201′ the request for resource allocation to the target SN 150. For example, the MN 110 may decide to configure CPA and enabling of a subsequent CPC for the terminal device 110. In this case, the MN 110 may transmit the request for resource allocation.

In some embodiments, the request may be a SN Addition Request message. Of course, any other suitable messages are also feasible. In some embodiments, the request may comprise information indicating that a subsequent CPC is enabled for at least one candidate cell. For example, the request may comprise at least one of an indication indicating that a subsequent CPC is enabled, or a list of candidate PSCells indicating the at least one candidate cell for which the subsequent CPC is enabled. In this way, enabling of subsequent CPC can be applied to all cells in the list of candidate PSCells, or can be applied to part of the cells in the list of candidate PSCells.

It is to be understood that the request may further comprise any other suitable information. For example, the request may comprise another list of candidate PSCells indicating all candidate PSCells for the terminal device 120.

As shown in FIG. 2, the target SN 140 may transmit 202 an acknowledgement for the request to the MN 110. The acknowledgement for the request may comprise an acknowledgement for the enabling of the subsequent CPC and a data forwarding address associated with the target SN 140. Similarly, the target SN 150 may also transmit 202′ an acknowledgement for the request to the MN 110. The acknowledgement for the request may comprise an acknowledgement for the enabling of the subsequent CPC and a data forwarding address associated with the target SN 150.

The MN 110 may transmit 203 a data forwarding address to the target SN 140, and may also transmit 203′ a data forwarding address to the target SN 150. In some embodiments, the data forwarding address may comprise a data forwarding address associated with the MN 110. In this way, the MN 110 provides indirect data forwarding between the target SNs. In some embodiments, the data forwarding address may comprise a data forwarding address associated with one or more other target SNs. For example, the MN 110 may transmit a data forwarding address associated with the target SN 150 to the target SN 140, and may also transmit a data forwarding address associated with the target SN 140 to the target SN 150. In this way, direct data forwarding between the target SNs may be used.

Continue to with reference to FIG. 2, the MN 110 may transmit 204 a conditional reconfiguration for a set of candidate cells to the terminal device 120. For example, the MN 110 may transmit an RRCReconfiguration message comprising the conditional reconfiguration to the terminal device 120. Of course, any other suitable messages are also feasible.

In some embodiments, the conditional reconfiguration may comprise information indicating that a subsequent CPC is enabled for at least one candidate cell in the set of candidate cells. In other words, the information indicating the enabling of the subsequent CPC may be applied to all conditional reconfiguration entries (i.e., all candidate PSCells). Alternatively, the information indicating the enabling of the subsequent CPC may be only applied to part of the conditional reconfiguration entries (i.e., part of candidate PSCells). For example, a list of conditional reconfiguration IDs (CondReconfigId) which support subsequent CPC may be provided. As another example, enabling of subsequent CPC may be configured for a conditional reconfiguration entry.

It is to be understood that the conditional reconfiguration may comprise any other suitable information. For example, the conditional reconfiguration may further comprise an execution condition for a CPA/CPC evaluation associated with each candidate cell.

Upon reception of the conditional reconfiguration, the terminal device 120 may transmit 205 an RRC reconfiguration complete message to the MN 110. For example, the terminal device 120 may apply RRC configuration excluding CPA/CPC configuration, store the CPA/CPC configuration, and reply to the MN 110 with the RRC reconfiguration complete message.

The terminal device 120 may start evaluate execution conditions for the set of candidate cells. In some embodiments, the terminal device 120 may detect 206 that an execution condition for a candidate cell (also referred to a selected candidate cell herein) is fulfilled. In this case, the terminal device 120 may perform a cell addition, i.e., CPA. In some embodiments, the terminal device 120 may receive 206′ an RRCReconfiguration message containing reconfigurationWithSync before an execution condition for any candidate cell is fulfilled. In this case, the terminal device 120 may also perform a cell addition, i.e., legacy PSCell addition.

For the cell addition (CPA or legacy PSCell addition), the terminal device 120 may apply RRC reconfiguration message corresponding to the target SN 140 and transmit 207 a MN RRC reconfiguration complete message to the MN 110. The MN RRC reconfiguration complete message comprises an SN RRC reconfiguration complete message for the target SN 140 and information (for example, conditional reconfiguration ID) of the selected candidate cell.

After the cell addition, the terminal device 120 does not remove (i.e., maintains) the stored CPA/CPC configurations and related measurement configuration, and continues to evaluate an execution condition for a candidate cell. In some embodiments, the terminal device 120 may maintain all the entries in the stored CPA/CPC configurations. In some embodiments, the terminal device 120 may remove the entries of conditional reconfiguration and related measurement configurations which subsequent CPC is not enabled (i.e., disabled), and maintain the entries of conditional reconfiguration and related measurement reconfiguration which subsequent CPC is enabled. In this way, a subsequent CPC is facilitated.

Upon reception of the MN RRC reconfiguration complete message, the MN 110 may transmit 208 the SN RRC reconfiguration complete message comprised in the MN RRC reconfiguration complete message to the selected candidate cell (in this example, the target SN 140).

Then, the terminal device 120 may perform 209 a synchronization towards the selected candidate cell (i.e., the target SN 140). The MN 110 may perform 210 a SN status transfer to the target SN 140. Data forwarding 211 may be performed from MN to the target SN 140. An update 222 of a user plane (UP) path towards the core network may be performed via a protocol data unit (PDU) session path update procedure. Then one ore multiple round of subsequent CPC 213 may be performed. The details of the subsequent CPC will be described later with reference to FIG. 5.

### 2. Example Implementation of MN-Initiated CPC With Subsequent CPC

FIG. 3 illustrates a schematic diagram illustrating an example process 300 of MN-initiated CPC with a subsequent CPC according to embodiments of the present disclosure. For the purpose of discussion, the process 300 will be described with reference to FIG. 1. The process 300 may involve the terminal device 120, the network devices 110, 130, 140 and 150, the UPF 161 and the AMF 162 as illustrated in FIG. 1. In this example, the network device 110 is a MN serving the terminal device 110, the network device 130 is a source SN serving the terminal device 110 and the network devices 140 and 150 are potential target SNs serving the terminal device 110.

As shown in FIG. 3, the MN 110 may transmit 301 a request for resource allocation to the target SN 140. The MN 110 may also transmit 301′ the request for resource allocation to the target SN 150. For example, the MN 110 may decide to configure CPC and enabling of a subsequent CPC for the terminal device 110. In this case, the MN 110 may transmit the request for resource allocation.

In some embodiments, the request may be a SN Addition Request message. Of course, any other suitable messages are also feasible. In some embodiments, the request may comprise information indicating that a subsequent CPC is enabled for at least one candidate cell. For example, the request may comprise at least one of an indication indicating that a subsequent CPC is enabled, or a list of candidate PSCells indicating the at least one candidate cell for which the subsequent CPC is enabled. In this way, enabling of subsequent CPC can be applied to all cells in the list of candidate PSCells, or can be applied to part of the cells in the list of candidate PSCells.

It is to be understood that the request may further comprise any other suitable information. For example, the request may comprise another list of candidate PSCells indicating all candidate PSCells for the terminal device 120.

The MN 110 may transmit 302 to source SN 130 a message comprising information indicating that a subsequent CPC is enabled for the at least one candidate cell. In some embodiments, the message may be a SN modification request message or any other suitable Xn messages. In some embodiments, the information may indicate the enabling of subsequent CPC and a list of candidate PSCells for which the subsequent CPC is enabled.

As shown in FIG. 3, the target SN 140 may transmit 303 an acknowledgement for the request to the MN 110. The acknowledgement for the request may comprise an acknowledgement for the enabling of the subsequent CPC and a data forwarding address associated with the target SN 140. Similarly, the target SN 150 may also transmit 303′ an acknowledgement for the request to the MN 110. The acknowledgement for the request may comprise an acknowledgement for the enabling of the subsequent CPC and a data forwarding address associated with the target SN 150.

The source SN 130 may transmit 304 an acknowledgement for the enabling of the subsequent CPC to the MN 110. In some embodiments, the source SN 130 may transmit an Xn message as the acknowledgement for the enabling of the subsequent CPC. For example, the Xn message may be a SN modification request acknowledge message or any other suitable Xn messages. In some embodiments, the Xn message may comprise at least one of a set of SCG radio configurations corresponding to the candidate PSCells of the source SN 130 in RRC reconfiguration, and a data forwarding address associated with the source SN 130.

The MN 110 may transmit 305 a data forwarding address to the target SN 140, and may also transmit 305′ a data forwarding address to the target SN 150. In some embodiments, the data forwarding address may comprise a data forwarding address associated with the MN 110. In this way, the MN 110 provides indirect data forwarding between the source SN and the target SNs. In some embodiments, the data forwarding address may comprise a data forwarding address associated with one or more other target SNs. For example, the MN 110 may transmit a data forwarding address associated with the target SN 150 to the target SN 140, and may also transmit a data forwarding address associated with the target SN 140 to the target SN 150. In some embodiments, the data forwarding address may comprise a data forwarding address associated with the source SN 130. For example, the MN 110 may transmit a data forwarding address associated with the source SN 130 to the target SN 140 and target SN 150. In this way, direct data forwarding can be enabled.

The MN 110 may also transmit 306 a data forwarding address to the source SN 130. In some embodiments, the data forwarding address may comprise a data forwarding address associated with the MN 110. In this way, the MN 110 provides indirect data forwarding between the source SN and the target SNs. In some embodiments, the data forwarding address may comprise data forwarding addresses associated with the target SNs 140 and 150. In this way, direct data forwarding can be enabled.

Continue to with reference to FIG. 3, the MN 110 may transmit 307 a conditional reconfiguration for a set of candidate cells to the terminal device 120. For example, the MN 110 may transmit an RRCReconfiguration message comprising the conditional reconfiguration to the terminal device 120. Of course, any other suitable messages are also feasible.

In some embodiments, the conditional reconfiguration may comprise information indicating that a subsequent CPC is enabled for at least one candidate cell in the set of candidate cells. In other words, the information indicating the enabling of the subsequent CPC may be applied to all conditional reconfiguration entries (i.e., all candidate PSCells). Alternatively, the information indicating the enabling of the subsequent CPC may be only applied to part of the conditional reconfiguration entries (i.e., part of candidate PSCells). For example, a list of conditional reconfiguration IDs (CondReconfigId) which support subsequent CPC may be provided. As another example, enabling of subsequent CPC may be configured for a conditional reconfiguration entry.

It is to be understood that the conditional reconfiguration may comprise any other suitable information. For example, the conditional reconfiguration may further comprise an execution condition for a CPA/CPC evaluation associated with each candidate cell.

Upon reception of the conditional reconfiguration, the terminal device 120 may transmit 308 an RRC reconfiguration complete message to the MN 110. For example, the terminal device 120 may apply RRC configuration excluding CPA/CPC configuration, store the CPA/CPC configuration, and reply to the MN 110 with the RRC reconfiguration complete message.

The terminal device 120 may start evaluate execution conditions for the set of candidate cells. In some embodiments, if the set of candidate cells comprise a serving cell of the terminal device 120 (in other words, one of the candidate cells is the PSCell of the terminal device 120), the terminal device 120 may not perform a conditional reconfiguration evaluation for the corresponding candidate cell. In some embodiments, if the candidate cell is different from a serving cell of the terminal device 120 (in other words, if the candidate cell is not the PSCell of the terminal device 120), the terminal device 120 may perform a conditional reconfiguration evaluation to the candidate cell.

In some embodiments, the terminal device 120 may detect 309 that an execution condition for a candidate cell (also referred to a selected candidate cell herein) is fulfilled. In this case, the terminal device 120 may perform a cell change, i.e., CPC. In some embodiments, if an execution condition for a candidate cell is fulfilled and the candidate cell is different from a serving cell of the terminal device 120 (in other words, if the candidate cell is not the PSCell of the terminal device 120), the terminal device 120 may perform the CPC to the candidate cell. In some embodiments, the terminal device 120 may receive 309′ an RRCReconfiguration message containing reconfigurationWithSync before an execution condition for any candidate cell is fulfilled. In this case, the terminal device 120 may also perform a cell change, i.e., legacy PSCell change.

For the cell change (CPC or legacy PSCell change), the terminal device 120 may apply RRC reconfiguration message corresponding to the target SN and transmit 310 a MN RRC reconfiguration complete message to the MN 110. The MN RRC reconfiguration complete message comprises an SN RRC reconfiguration complete message for the target SN and information (for example, conditional reconfiguration ID) of the selected candidate cell.

After the cell change, the terminal device 120 does not remove (i.e., maintains) the stored CPA/CPC configurations and related measurement configuration, and continues to evaluate an execution condition for a candidate cell. In some embodiments, the terminal device 120 may maintain all the entries in the stored CPA/CPC configurations. In some embodiments, the terminal device 120 may remove the entries of conditional reconfiguration and related measurement configurations which subsequent CPC is not enabled (i.e., disabled), and maintain the entries of conditional reconfiguration and related measurement reconfiguration which subsequent CPC is enabled. In this way, a subsequent CPC is facilitated.

Upon reception of the MN RRC reconfiguration complete message, the MN 110 may transmit 311 a notification to the source SN 130, the notification indicating that user data is stopped to be provided to the terminal device 120. In some embodiments, the notification may comprise an address of the selected candidate cell. If the address is applicable, the source SN 130 may start late data forwarding.

The MN 110 may transmit 312 the SN RRC reconfiguration complete message comprised in the MN RRC reconfiguration complete message to the target SN (in this example, the target SN 140).

Then, the terminal device 120 may perform 313 a synchronization towards the selected candidate cell (i.e., the target SN 140). The source SN 130 may transmit 314 a SN status transfer to the MN 110. The MN 110 may forward 315 the SN status transfer to the target SN 140. Data forwarding 316 may be performed from the source SN to the target SN 140. The source SN may transmit 317 a secondary RAT data usage report message to the MN 110. An update 318 of an UP path towards the core network may be performed via a PDU session path update procedure. The MN 110 may transmit 319 a UE context release message to the source SN 130. The source SN 130 may release radio and control plane related resources associated with the UE context. Then one or multiple round of subsequent CPC 320 may be performed. The details of the subsequent CPC will be described later with reference to FIG. 5.

### 3. Example Implementation of SN-Initiated CPC With Subsequent CPC

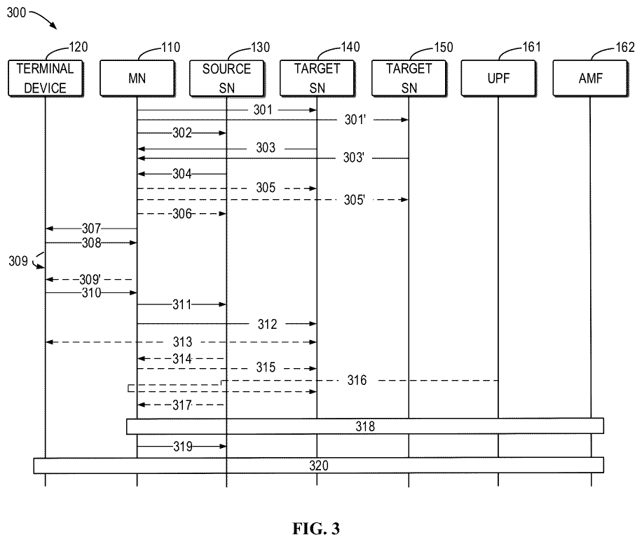

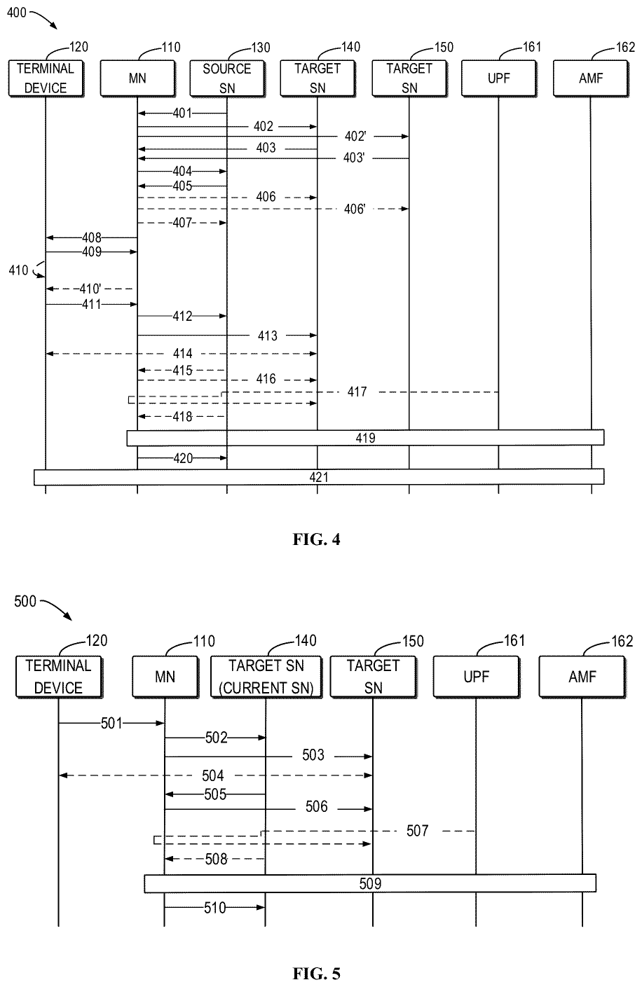

FIG. 4 illustrates a schematic diagram illustrating an example process 400 of SN-initiated CPC with a subsequent CPC according to embodiments of the present disclosure. For the purpose of discussion, the process 400 will be described with reference to FIG. 1. The process 400 may involve the terminal device 120, the network devices 110, 130, 140 and 150, the UPF 161 and the AMF 162 as illustrated in FIG. 1. In this example, the network device 110 is a MN serving the terminal device 110, the network device 130 is a source SN serving the terminal device 110 and the network devices 140 and 150 are potential target SNs serving the terminal device 110.

As shown in FIG. 4, the source SN 130 may transmit 401 a request for CPC to the MN 110. In some embodiments, the request for CPC may comprise information indicating that a subsequent CPC is enabled for at least one candidate cell in a set of candidate cells. In some embodiments, the request for CPC may comprise a data forwarding address associated with the source SN 130. For example, the source SN 130 may decide to configure CPC and enabling of a subsequent CPC for the terminal device 110. In this case, the source SN 130 may transmit the request for CPC.

Upon reception of the request for CPC from the source SN 130, the MN 110 may transmit 402 a request for resource allocation to the target SN 140. The MN 110 may also transmit 402′ the request for resource allocation to the target SN 150.

In some embodiments, the request for resource allocation may be a SN Addition Request message. Of course, any other suitable messages are also feasible. In some embodiments, the request for resource allocation may comprise the information indicating that a subsequent CPC is enabled for the at least one candidate cell. For example, the request for resource allocation may comprise at least one of an indication indicating that a subsequent CPC is enabled, or a list of candidate PSCells indicating the at least one candidate cell for which the subsequent CPC is enabled. In this way, enabling of subsequent CPC can be applied to all cells in the list of candidate PSCells, or can be applied to part of the cells in the list of candidate PSCells.

For SN-initiated CPC, an execution condition is based on a measurement configuration. In a conventional solution, a target SN cannot obtain a measurement configuration of a source SN for SN-initiated CPC, and may reconfigure a measurement ID of the source SN. In this case, a terminal device cannot get correct execution condition of the subsequent CPC. In view of this, in some embodiments, the request for resource allocation may comprise information of a measurement configuration associated with the source SN 130. In this way, the terminal device 120 can correctly know the execution condition of the subsequent CPC.

It is to be understood that the request for resource allocation may further comprise any other suitable information. For example, the request may comprise another list of candidate PSCells indicating all candidate PSCells for the terminal device 120.

As shown in FIG. 4, the target SN 140 may transmit 403 an acknowledgement for the request to the MN 110. The acknowledgement for the request may comprise an acknowledgement for the enabling of the subsequent CPC and a data forwarding address associated with the target SN 140. Similarly, the target SN 150 may also transmit 403′ an acknowledgement for the request to the MN 110. The acknowledgement for the request may comprise an acknowledgement for the enabling of the subsequent CPC and a data forwarding address associated with the target SN 150.

The MN 110 may indicate 404, to the source SN 130, one or more candidate PSCells accepted by target SNs. The source SN 130 may transmit 405 updated measurement configurations to the MN 110.

The MN 110 may transmit 406 a data forwarding address to the target SN 140, and may also transmit 406′ a data forwarding address to the target SN 150. In some embodiments, the data forwarding address may comprise a data forwarding address associated with the MN 110. In this way, the MN 110 provides indirect data forwarding between the source SN and the target SNs. In some embodiments, the data forwarding address may comprise a data forwarding address associated with one or more other target SNs. For example, the MN 110 may transmit a data forwarding address associated with the target SN 150 to the target SN 140, and may also transmit a data forwarding address associated with the target SN 140 to the target SN 150. In some embodiments, the data forwarding address may comprise a data forwarding address associated with the source SN 130. For example, the MN 110 may transmit a data forwarding address associated with the source SN 130 to the target SN 140 and target SN 150. In this way, direct data forwarding between the target SNs and source SN can be enabled.

The MN 110 may also transmit 407 a data forwarding address to the source SN 130. In some embodiments, the data forwarding address may comprise a data forwarding address associated with the MN 110. In this way, the MN 110 provides indirect data forwarding between the source SN and the target SNs. In some embodiments, the data forwarding address may comprise data forwarding addresses associated with the target SNs 140 and 150. In this way, direct data forwarding can be enabled.

Continue to with reference to FIG. 4, the MN 110 may transmit 408 a conditional reconfiguration for a set of candidate cells to the terminal device 120. For example, the MN 110 may transmit an RRCReconfiguration message comprising the conditional reconfiguration to the terminal device 120. Of course, any other suitable messages are also feasible.

In some embodiments, the conditional reconfiguration may comprise information indicating that a subsequent CPC is enabled for at least one candidate cell in the set of candidate cells. In other words, the information indicating the enabling of the subsequent CPC may be applied to all conditional reconfiguration entries (i.e., all candidate PSCells). Alternatively, the information indicating the enabling of the subsequent CPC may be only applied to part of the conditional reconfiguration entries (i.e., part of candidate PSCells). For example, a list of conditional reconfiguration IDs (CondReconfigId) which support subsequent CPC may be provided. As another example, enabling of subsequent CPC may be configured for a conditional reconfiguration entry.

It is to be understood that the conditional reconfiguration may comprise any other suitable information. For example, the conditional reconfiguration may further comprise an execution condition for a CPA/CPC evaluation associated with each candidate cell.

Upon reception of the conditional reconfiguration, the terminal device 120 may transmit 409 an RRC reconfiguration complete message to the MN 110. For example, the terminal device 120 may apply RRC configuration excluding CPA/CPC configuration, store the CPA/CPC configuration, and reply to the MN 110 with the RRC reconfiguration complete message.

The terminal device 120 may start evaluate execution conditions for the set of candidate cells. In some embodiments, if the set of candidate cells comprise a serving cell of the terminal device 120 (in other words, one of the candidate cells is the PSCell of the terminal device 120), the terminal device 120 may not perform a conditional reconfiguration evaluation for the corresponding candidate cell. In some embodiments, if the candidate cell is different from a serving cell of the terminal device 120 (in other words, if the candidate cell is not the PSCell of the terminal device 120), the terminal device 120 may perform a conditional reconfiguration evaluation to the candidate cell.

In some embodiments, the terminal device 120 may detect 410 that an execution condition for a candidate cell (also referred to a selected candidate cell herein) is fulfilled. In this case, the terminal device 120 may perform a cell change, i.e., CPC. In some embodiments, if the execution condition for the candidate cell is fulfilled and the candidate cell is different from a serving cell of the terminal device 120 (in other words, if the candidate cell is not the PSCell of the terminal device 120), the terminal device 120 may perform the CPC to the candidate cell. In some embodiments, the terminal device 120 may receive 410′ an RRCReconfiguration message containing reconfiguration WithSync before an execution condition for any candidate cell is fulfilled. In this case, the terminal device 120 may also perform a cell change, i.e., legacy PSCell change.

For the cell change (CPC or legacy PSCell change), the terminal device 120 may apply RRC reconfiguration message corresponding to the target SN and transmit 411 a MN RRC reconfiguration complete message to the MN 110. The MN RRC reconfiguration complete message comprises an SN RRC reconfiguration complete message for the target SN and information (for example, conditional reconfiguration ID) of the selected candidate cell.

After the cell change, the terminal device 120 does not remove (i.e., maintains) the stored CPA/CPC configurations and related measurement configuration, and continues to evaluate an execution condition for a candidate cell. In some embodiments, the terminal device 120 may maintain all the entries in the stored CPA/CPC configurations. In some embodiments, the terminal device 120 may remove the entries of conditional reconfiguration and related measurement reconfiguration which subsequent CPC is not enabled (i.e., disabled), and maintain the entries of conditional reconfiguration and related measurement reconfiguration which subsequent CPC is enabled. In this way, a subsequent CPC is facilitated.

Upon reception of the MN RRC reconfiguration complete message, the MN 110 may transmit 412 a notification to the source SN 130, the notification indicating that user data is stopped to be provided to the terminal device 120. In some embodiments, the notification may comprise an address of the selected candidate cell. If the address is applicable, the source SN 130 may start late data forwarding.

The MN 110 may transmit 413 the SN RRC reconfiguration complete message comprised in the MN RRC reconfiguration complete message to the selected candidate cell (in this example, the target SN 140).

Then, the terminal device 120 may perform 414 a synchronization towards the selected candidate cell (i.e., the target SN 140). The source SN 130 may transmit 415 a SN status transfer to the MN 110. The MN 110 may forward 416 the SN status transfer to the target SN 140. Data forwarding 417 may be performed from the source SN to the target SN 140. The source SN may transmit 418 a secondary RAT data usage report message to the MN 110. An update 419 of an UP path towards the core network may be performed via a PDU session path update procedure. The MN 110 may transmit 420 a UE context release message to the source SN 130. The source SN 130 may release radio and control plane related resources associated with the UE context. Then one or multiple round of subsequent CPC 421 may be performed. The details of the subsequent CPC will be described later with reference to FIG. 5.

### 4. Example Implementation of Subsequent CPC

FIG. 5 illustrates a schematic diagram illustrating an example process 500 of a subsequent CPC according to embodiments of the present disclosure. For the purpose of discussion, the process 500 will be described with reference to FIG. 1. The process 500 may involve the terminal device 120, the network devices 110, 130, 140 and 150, the UPF 161 and the AMF 162 as illustrated in FIG. 1. The process 500 may implement the above subsequent CPC 213, 320 or 421.

In this example, the network device 110 is a MN serving the terminal device 110, and the network device 150 is a potential target SN serving the terminal device 110. Current SN is the network device of a current serving cell of the terminal device 110. For convenience, the following description may be given by taking the target SN 140 as an example of the current SN.

After the legacy PSCell change/addition, CPA or CPC, the terminal device 120 may continue to evaluate execution conditions for the at least one candidate cell for which a subsequent CPC is enabled.

In some embodiments, if the set of candidate cells comprise a serving cell of the terminal device 120 (in other words, one of the candidate cells is the PSCell of the terminal device 120), the terminal device 120 may not perform a conditional reconfiguration evaluation for the corresponding candidate cell. In some embodiments, if the candidate cell is different from a serving cell of the terminal device 120 (in other words, if the candidate cell is not the PSCell of the terminal device 120), the terminal device 120 may perform a conditional reconfiguration evaluation to the candidate cell.

If an execution condition for a candidate cell (also referred to as a selected candidate cell hereinafter) is fulfilled, the terminal device 120 may perform a subsequent CPC. In this example, the selected candidate cell is provided by the target SN 150. In some embodiments, if the execution condition for the candidate cell is fulfilled and the candidate cell is different from a serving cell of the terminal device 120 (in other words, if the candidate cell is not the PSCell of the terminal device 120), the terminal device 120 may perform the subsequent CPC to the candidate cell.

As shown in FIG. 5, the terminal device 120 may transmit 501 a MN RRC reconfiguration complete message to the MN 110. The MN RRC reconfiguration complete message comprises an SN RRC reconfiguration complete message for the target SN 150 and information (for example, conditional reconfiguration ID) of the selected candidate cell.

Upon reception of the MN RRC reconfiguration complete message, the MN 110 may transmit 502 a notification to the current SN 140, the notification indicating that user data is stopped to be provided to the terminal device 120. In some embodiments, the notification may comprise an address of the selected candidate cell. If the address is applicable, the current SN 140 may start late data forwarding.

The MN 110 may transmit 503 the SN RRC reconfiguration complete message comprised in the MN RRC reconfiguration complete message to the selected candidate cell (in this example, the target SN 150).

Then, the terminal device 120 may perform 504 a synchronization towards the selected candidate cell (i.e., one cell of the target SN 150). The current SN 140 may transmit 505 a SN status transfer to the MN 110. The MN 110 may forward 506 the SN status transfer to the target SN 150. Data forwarding 507 may be performed from the current SN 140 to at least one of the MN 110, target SNs (i.e. network device 150 and network device 130). In case of indirect data forwarding, data is forwarded from the current SN 140 to the MN 110, and the MN 130 forwards the data to at least one of the target SNs (e.g. target SN 150 and source SN 130). In case of direct data forwarding, the current SN 140 forwards data to at least one of the target SNs, e.g. target SN 150 and source SN 130. This data forwarding may be started as early as after 208/209 in FIG. 2, 312/313 in FIG. 3, 413/414 in FIG. 4 or 503/504 in FIG. 5, which is after reception of RRC Reconfiguration Complete message from MN 110 or after performing random access procedure with the terminal device 120, in other words after the network device becomes the current SN 140 of the UE. The current SN 140 may transmit 508 a secondary RAT data usage report message to the MN 110. An update 509 of an UP path towards the core network may be performed via a PDU session path update procedure. The MN 110 may transmit 510 a UE context release message to the current SN 140. The current SN 140 may release radio and control plane related resources associated with the UE context. By repeating the above process 500, more subsequent CPC may be performed.

So far, a procedure of enabling and performing a subsequent CPC is provided. It is to be understood that the above processes are also applied to conditional PCell change or addition.

It is to be understood that the steps and the order of the steps in FIGS. 2 to 5 are merely for illustration, and not for limitation.

### 5. Example Implementation of Avoid of Ping-Pong Issue Of Subsequent CPC

If CPA/CPC is configured to a terminal device and subsequent CPC is supported, the terminal device may perform execution condition evaluation. With a frequent cell change, a ping-pong issue may happen. For example, the terminal device may perform PSCell changes back and forth, and stays at each cell for a very short time. This will result in bad performance.

Embodiments of the present disclosure provide a solution to avoid the above ping-pong issue. In the solution, a timer is configured to control conditional reconfiguration evaluation for subsequent CPC.

In some embodiments, the terminal device 120 may receive a configuration of a timer from the MN 110. If the (legacy or conditional) cell change or addition or the subsequent conditional cell change is completed successfully, the terminal device 120 may start the timer while suspending a conditional reconfiguration evaluation. If the timer expires, the terminal device 120 may resume the conditional reconfiguration evaluation.

In this way, the above Ping-Pong issue may be alleviated.

### Example Implementation of Methods

Accordingly, embodiments of the present disclosure provide methods of communication implemented at a terminal device and a network device. These methods will be described below with reference to FIGS. 6 to 10.

FIG. 6 illustrates an example method 600 of communication implemented at a terminal device in accordance with some embodiments of the present disclosure. For example, the method 600 may be performed at the terminal device 120 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the terminal device 120 receives, from a first network device (for example, the network device 110) as a MN, a conditional reconfiguration for a set of candidate cells, the conditional reconfiguration comprising information indicating that a subsequent conditional cell change is enabled for at least one candidate cell in the set of candidate cells.

At block 620, the terminal device 120 determines whether a cell change or addition is performed. In some embodiments, the terminal device 120 may perform a conditional reconfiguration evaluation for the set of candidate cells based on the conditional reconfiguration. If a condition for a candidate cell in the set of candidate cells is satisfied, the terminal device 120 may perform the cell change or addition to the candidate cell. In some embodiments, if the candidate cell is a serving cell of the terminal device 120, the terminal device 120 may perform no conditional reconfiguration evaluation for the candidate cell. In some embodiments, if the candidate cell is different from a serving cell of the terminal device 120, the terminal device 120 may perform the cell change or addition to the candidate cell.

If the cell change or addition is performed, the process 600 proceeds to block 630. At block 630, the terminal device 120 maintains at least a portion of the conditional reconfiguration for use in the subsequent conditional cell change.

In some embodiments, the terminal device 120 may perform a conditional reconfiguration evaluation for the at least one candidate cell in the set of candidate cells based on the conditional reconfiguration. If a condition for a candidate cell in the at least one candidate cell is satisfied, the terminal device 110 may the subsequent conditional cell change to the candidate cell. In some embodiments, if the candidate cell is a serving cell of the terminal device 120, the terminal device 120 may not perform a conditional reconfiguration evaluation for the candidate cell. In some embodiments, if the candidate cell is different from a serving cell of the terminal device 120, the terminal device 120 may perform the subsequent conditional cell change to the candidate cell.

In some embodiments, the terminal device 120 may further receive a configuration of a timer from the network device 130. If the cell change or addition or the subsequent conditional cell change is completed successfully, the terminal device 120 may start the timer while suspending a conditional reconfiguration evaluation. If the timer expires, the terminal device 120 may resume the conditional reconfiguration evaluation.

In some embodiments, the terminal device 120 may maintain the conditional reconfiguration for the set of candidate cells. In some embodiments, the terminal device 120 may maintain a portion (also referred to as a first portion herein) of the conditional reconfiguration for the at least one candidate cell while removing a portion (also referred to as a second portion herein) of the conditional reconfiguration for at least one candidate cell for which the subsequent conditional cell change is disabled in the set of candidate cells.

In this way, a procedure of subsequent conditional cell change after cell change or addition may be provided.

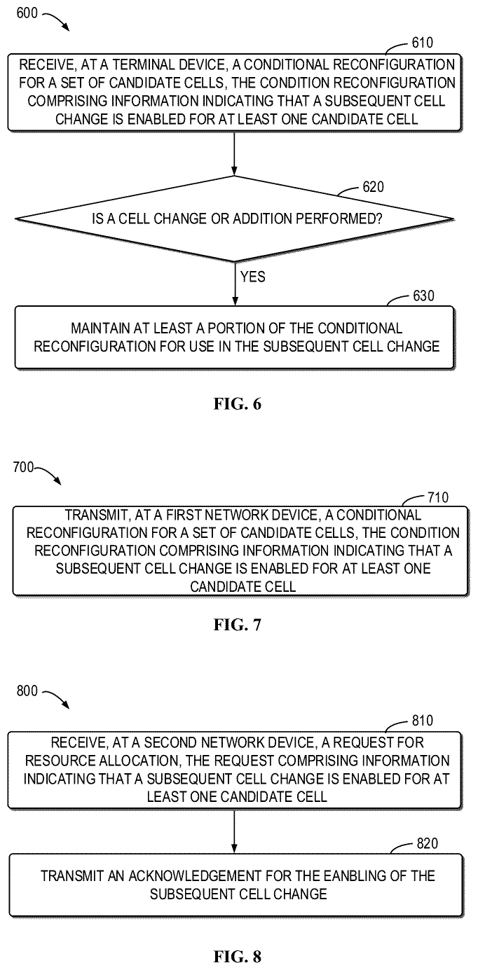

FIG. 7 illustrates an example method 700 of communication implemented at a first network device as a MN in accordance with some embodiments of the present disclosure. For example, the method 700 may be performed at the network device 110 as shown in FIG. 1. The network device 110 may be a MN. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

As shown in FIG. 7, at block 710, the network device 110 transmits, to the terminal device 110, a conditional reconfiguration for a set of candidate cells, the conditional reconfiguration comprising information indicating that a subsequent conditional cell change is enabled for at least one candidate cell in the set of candidate cells.

In some embodiments, the network device 110 may further transmit, to a set of second network devices (for example, the network devices 140 and 150), a request for resource allocation, the request comprising the information indicating that the subsequent conditional cell change is enabled for the at least one candidate cell.

In some embodiments, the network device 110 may receive, from each second network device in the set of second network devices, an acknowledgement for the enabling of the subsequent conditional cell change and a data forwarding address associated with the second network device.

In some embodiments, the network device 110 may further transmit, to a third network device (for example, the network device 130) as a source SN, a message comprising the information indicating that the subsequent conditional cell change is enabled for the at least one candidate cell. In some embodiments, the network device 110 may further receive, from the third network device, an acknowledgement for the enabling of the subsequent conditional cell change. In some embodiments, the acknowledgement may comprise a data forwarding address associated with the third network device.

In some embodiments, the network device 110 may further receive, from the third network device, a request for a conditional cell change, the request comprising at least one of a data forwarding address associated with the third network device or the information indicating that the subsequent conditional cell change is enabled for the at least one candidate cell in the set of candidate cells.

In some embodiments, the network device 110 may further transmit, to the set of second network devices, information of a measurement configuration of the third network device.

In some embodiments, the network device 110 may transmit a data forwarding address to the set of second network devices. In some embodiments, the data forwarding address comprises at least one of a data forwarding address associated with the third network device, a data forwarding address associated with the first network device, or a set of data forwarding addresses associated with the set of second network devices.

In some embodiments, the network device 110 may forward data received from a serving network device of the terminal device to at least one of a set of second network devices.

In some embodiments, the network device 110 may transmit a configuration of a timer to the terminal device 120, a conditional reconfiguration evaluation for the subsequent conditional cell change being suspended during running of the timer.

In this way, a procedure of subsequent conditional cell change after cell change or addition may be provided.

FIG. 8 illustrates an example method 800 of communication implemented at a second network device as a target SN in accordance with some embodiments of the present disclosure. For example, the method 800 may be performed at the network device 140 or 150 as shown in FIG. 1. For the purpose of discussion, in the following, the method 800 will be described with reference to the network device 140 in FIG. 1. It is to be understood that the method 800 may include additional blocks not shown and/or may omit some blocks as shown, and the scope of the present disclosure is not limited in this regard.

As shown in FIG. 8, at block 810, the network device 140 receives, from a first network device (for example, the network device 110) as a MN, a request for resource allocation, the request comprising information indicating that a subsequent conditional cell change is enabled for at least one candidate cell in a set of candidate cells.

At block 820, the network device 140 may transmit, to the network device 110, an acknowledgement for the enabling of the subsequent conditional cell change and a data forwarding address associated with the network device 140.

In some embodiments, the network device 140 may receive, from the network device 110, information of a measurement configuration of a third network device (for example, the network device 130) as a source SN.

In some embodiments, the network device 140 may receive a data forwarding address from the network device 110. In some embodiments, the data forwarding address comprises at least one of a data forwarding address associated with the network device 130, a data forwarding address associated with the network device 110, or a set of data forwarding addresses associated with a set of second network devices (i.e., one or more other target SNs, for example, the network device 150).

In some embodiments, the network device 140 may perform data forwarding to at least one of the first network device, the set of second network devices, and the third network device.

In some embodiments, the network device 140 may start the data forwarding in response to one of the following: receiving a RRC reconfiguration complete message from the first network device, or performing a random access procedure with the terminal device 120.

In this way, a procedure of subsequent conditional cell change after cell change or addition may be provided.

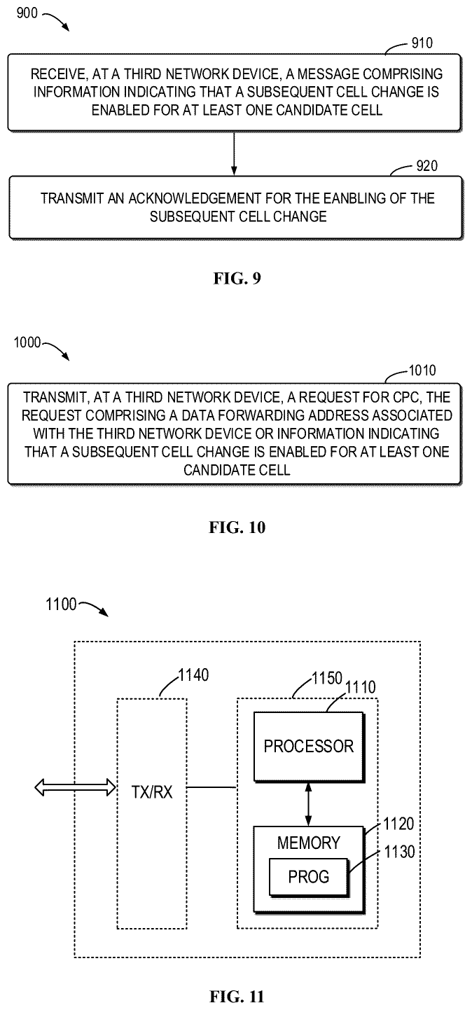

FIG. 9 illustrates an example method 900 of communication implemented at a third network device as a source SN in accordance with some embodiments of the present disclosure. For example, the method 900 may be performed at the network device 130 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

As shown in FIG. 9, at block 910, the network device 130 receives, from a first network device (for example, the network device 110) as a MN, a message comprising information indicating that a subsequent conditional cell change is enabled for at least one candidate cell in a set of candidate cells.

At block 920, the network device 130 transmits, to the network device 110, an acknowledgement for the enabling of the subsequent conditional cell change. In some embodiments, the acknowledgement may comprise a data forwarding address associated with the network device 130.

In some embodiments, the network device 130 may receive, from the network device 110, a set of data forwarding addresses associated with a set of second network devices (for example, the network devices 140 and 150), and perform a data forwarding to the set of second network devices based on the set of data forwarding addresses.

In this way, a subsequent conditional cell change after cell change or addition may be supported.

FIG. 10 illustrates an example method 1000 of communication implemented at a third network device as a source SN in accordance with some embodiments of the present disclosure. For example, the method 1000 may be performed at the network device 130 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the network device 130 transmits, to a first network device (for example, the network device 110) as a MN, a request for a conditional cell change, the request comprising at least one of a data forwarding address associated with the network device 130 or information indicating that a subsequent conditional cell change is enabled for at least one candidate cell in a set of candidate cells.

In some embodiments, the network device 130 may receive, from the network device 110, a set of data forwarding addresses associated with a set of second network devices (for example, the network devices 140 and 150), and perform a data forwarding to the set of second network devices based on the set of data forwarding addresses.

In this way, a procedure of subsequent conditional cell change after cell change or addition may be enabled.

### Example Implementation of Device

FIG. 11 is a simplified block diagram of a device 1100 that is suitable for implementing embodiments of the present disclosure. The device 1100 can be considered as a further example implementation of the terminal device 120 or the network device 110, 130, 140 or 150 as shown in FIG. 1. Accordingly, the device 1100 can be implemented at or as at least a part of the terminal device 110 or the network device 110, 130, 140 or 150.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a terminal device comprises circuitry configured to: receive, from a first network device, a conditional reconfiguration for a set of candidate cells, the conditional reconfiguration comprising information indicating that a subsequent conditional cell change is enabled for at least one candidate cell in the set of candidate cells; and in accordance with a determination that a cell change or addition is performed, maintain at least a portion of the conditional reconfiguration for use in the subsequent conditional cell change.

In some embodiments, the circuitry may be further configured to: perform a conditional reconfiguration evaluation for the at least one candidate cell in the set of candidate cells based on the conditional reconfiguration; and in accordance with a determination that a condition for a candidate cell in the at least one candidate cell is satisfied, perform the subsequent conditional cell change to the candidate cell.

In some embodiments, the circuitry may be further configured to: in accordance with a determination that the candidate cell is a serving cell of the terminal device, perform no conditional reconfiguration evaluation for the candidate cell.

In some embodiments, the circuitry may be configured to perform the subsequent conditional cell change by: in accordance with a determination that the candidate cell is different from a serving cell of the terminal device, perform the subsequent conditional cell change to the candidate cell.

In some embodiments, the circuitry may be further configured to: perform a conditional reconfiguration evaluation for the set of candidate cells based on the conditional reconfiguration; and in accordance with a determination that a condition for a candidate cell in the set of candidate cells is satisfied, perform the cell change or addition to the candidate cell.

In some embodiments, the circuitry may be further configured to: in accordance with a determination that the candidate cell is a serving cell of the terminal device, perform no conditional reconfiguration evaluation for the candidate cell.

In some embodiments, the circuitry may be configured to perform the cell change or addition by: in accordance with a determination that the candidate cell is different from a serving cell of the terminal device, perform the cell change or addition to the candidate cell.

In some embodiments, the circuitry may be further configured to: receive a configuration of a timer from the first network device; in accordance with a determination that the cell change or addition or the subsequent conditional cell change is completed successfully, start the timer while suspending a conditional reconfiguration evaluation; and in accordance with a determination that the timer expires, resume the conditional reconfiguration evaluation.

In some embodiments, the circuitry may be configured to maintain the at least a portion of the conditional reconfiguration by: maintaining the conditional reconfiguration for the set of candidate cells; or maintaining a first portion of the conditional reconfiguration for the at least one candidate cell while removing a second portion of the conditional reconfiguration for at least one candidate cell for which the subsequent conditional cell change is disabled in the set of candidate cells.

In some embodiments, a first network device comprises a circuitry configured to: transmit, to a terminal device, a conditional reconfiguration for a set of candidate cells, the conditional reconfiguration comprising information indicating that a subsequent conditional cell change is enabled for at least one candidate cell in the set of candidate cells.

In some embodiments, the circuitry may be further configured to transmit, to a set of second network devices, a request for resource allocation, the request comprising the information indicating that the subsequent conditional cell change is enabled for the at least one candidate cell.

In some embodiments, the circuitry may be further configured to receive, from a second network device in the set of second network devices, an acknowledgement for the enabling of the subsequent conditional cell change and a data forwarding address associated with the second network device.

In some embodiments, the circuitry may be further configured to transmit, to a third network device, a message comprising the information indicating that the subsequent conditional cell change is enabled for the at least one candidate cell. In some embodiments, the circuitry may be further configured to receive, from the third network device, an acknowledgement for the enabling of the subsequent conditional cell change. In some embodiments, the acknowledgement may comprise a data forwarding address associated with the third network device.

In some embodiments, the circuitry may be further configured to receive, from a third network device, a request for a conditional cell change, the request comprising at least one of a data forwarding address associated with the third network device or the information indicating that the subsequent conditional cell change is enabled for the at least one candidate cell in the set of candidate cells.

In some embodiments, the circuitry may be further configured to transmit, to the set of second network devices, information of a measurement configuration of the third network device.

In some embodiments, the circuitry may be further configured to transmit a data forwarding address to the set of second network devices. In some embodiments, the data forwarding address comprises at least one of a data forwarding address associated with the third network device, a data forwarding address associated with the first network device, or a set of data forwarding addresses associated with the set of second network devices.

In some embodiments, the circuitry may be further configured to forward data received from a serving network device of the terminal device to at least one of a set of second network devices.

In some embodiments, the circuitry may be further configured to transmit a configuration of a timer to the terminal device, a conditional reconfiguration evaluation for the subsequent conditional cell change being suspended during running of the timer.

In some embodiments, a second network device comprises a circuitry configured to: receive, from a first network device, a request for resource allocation, the request comprising information indicating that a subsequent conditional cell change is enabled for at least one candidate cell in a set of candidate cells; and transmit, to the first network device, an acknowledgement for the enabling of the subsequent conditional cell change and a data forwarding address associated with the second network device.

In some embodiments, the circuitry may be further configured to receive, from the first network device, information of a measurement configuration of a third network device.

In some embodiments, the circuitry may be further configured to receive a data forwarding address from the first network device. In some embodiments, the data forwarding address comprises at least one of a data forwarding address associated with a third network device, a data forwarding address associated with the first network device, or a set of data forwarding addresses associated with a set of second network devices.

In some embodiments, the circuitry may be further configured to perform a data forwarding to at least one of the first network device, a set of second network devices, and a third network device.

In some embodiments, the circuitry may be further configured to start the data forwarding in response to one of the following: receiving a RRC reconfiguration complete message from the first network device, or performing a random access procedure with the terminal device.

In some embodiments, a third network device comprises a circuitry configured to: receive, from a first network device, a message comprising information indicating that a subsequent conditional cell change is enabled for at least one candidate cell in a set of candidate cells; and transmit, to the first network device, an acknowledgement for the enabling of the subsequent conditional cell change. In some embodiments, the acknowledgement may comprise a data forwarding address associated with the third network device.

In some embodiments, the circuitry may be further configured to: receive, from the first network device, a set of data forwarding addresses associated with a set of second network devices; and perform a data forwarding to the set of second network devices based on the set of data forwarding addresses.

In some embodiments, a third network device comprises a circuitry configured to: transmit, at a third network device and to a first network device, a request for a conditional cell change, the request comprising at least one of a data forwarding address associated with the third network device or information indicating that a subsequent conditional cell change is enabled for at least one candidate cell in a set of candidate cells.

In some embodiments, the circuitry may be further configured to: receive, from the first network device, a set of data forwarding addresses associated with a set of second network devices; and perform a data forwarding to the set of second network devices based on the set of data forwarding addresses.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-33. (canceled)

34. A method of a User Equipment (UE), the method comprising:
receiving, from a Master Node (MN) in a dual connectivity, a Radio Resource Control (RRC) Reconfiguration message which includes a configuration for a subsequent Conditional PSCell Addition or Change; and
keeping the configuration for the subsequent Conditional PSCell Addition or Change after completion of a PSCell addition or a PSCell change.

35. The method according to claim 34, further comprising:
removing all entries in a conditional reconfiguration except for entries in which the configuration for the subsequent Conditional PSCell Addition or Change is supported.

36. The method according to claim 34,
wherein the configuration contains an execution condition for the subsequent Conditional PSCell Addition or Change, and
wherein the method further comprises:
evaluating the execution condition after the completion of the PSCell addition or the PSCell change;
applying the RRC Reconfiguration message in a case where the execution condition is satisfied; and
sending, to the MN, an MN RRC Reconfiguration Complete message in a case where the execution condition is satisfied.

37. The method according to claim 34, further comprising:
performing a conditional reconfiguration evaluation in a case where a candidate cell is not a PSCell.

38. The method according to claim 34,
wherein the dual connectivity is a Multi-Radio Dual Connectivity (MR-DC).

39. A method of a Radio Access Network (RAN) node which acts as a Master Node (MN) in a dual connectivity, the method comprising:
sending, to a User Equipment (UE), a Radio Resource Control (RRC) Reconfiguration message which includes a configuration for a subsequent Conditional PSCell Addition or Change,
wherein the configuration for the subsequent Conditional PSCell Addition or Change is kept in the UE after completion of a PSCell addition or a PSCell change.

40. The method according to claim 39, further comprising:
sending, to a candidate Secondary Node (SN), an Xn message to request to allocate a resource for the UE by an SN Addition procedure, wherein the Xn message includes a list of candidate PSCells for the subsequent Conditional PSCell Addition or Change.

41. The method according to claim 39, further comprising:
receiving, from a source Secondary Node (SN), a request for the subsequent Conditional PSCell Addition or Change.

42. The method according to claim 39,
wherein the dual connectivity is a Multi-Radio Dual Connectivity (MR-DC).

43. A User Equipment (UE) comprising:
a memory; and
a processor coupled with the memory, wherein the processor is configured to:
receive, from a Master Node (MN) in a dual connectivity, a Radio Resource Control (RRC) Reconfiguration message which includes a configuration for a subsequent Conditional PSCell Addition or Change, and
keep the configuration for the subsequent Conditional PSCell Addition or Change after completion of a PSCell addition or a PSCell change.

44. The UE according to claim 43,
wherein the processor is configured to:
remove all entries in a conditional reconfiguration except for entries in which the configuration for the subsequent Conditional PSCell Addition or Change is supported.

45. The UE according to claim 43,
wherein the configuration contains an execution condition for the subsequent Conditional PSCell Addition or Change, and
wherein the processor is configured to:
evaluate the execution condition after the completion of the PSCell addition or the PSCell change,
apply the RRC Reconfiguration message in a case where the execution condition is satisfied, and
send, to the MN, an MN RRC Reconfiguration Complete message in a case where the execution condition is satisfied.

46. The UE according to claim 43,
wherein the processor is configured to:
perform a conditional reconfiguration evaluation in a case where a candidate cell is not a PSCell.

47. The UE according to claim 43,
wherein the dual connectivity is a Multi-Radio Dual Connectivity (MR-DC).

48. A Radio Access Network (RAN) node which acts as a Master Node (MN) in a dual connectivity, the RAN node comprising:
a memory; and
a processor coupled with the memory, wherein the processor is configured to:
send, to a User Equipment (UE), a Radio Resource Control (RRC) Reconfiguration message which includes a configuration for a subsequent Conditional PSCell Addition or Change,
wherein the configuration for the subsequent Conditional PSCell Addition or Change is kept in the UE after completion of a PSCell addition or a PSCell change.

49. The RAN node according to claim 48,
wherein the processor is configured to:
send, to a candidate Secondary Node (SN), an Xn message to request to allocate a resource for the UE by an SN Addition procedure, wherein the Xn message includes a list of candidate PSCells for the subsequent Conditional PSCell Addition or Change.

50. The RAN node according to claim 48,
wherein the processor is configured to:
receive, from a source Secondary Node (SN), a request for the subsequent Conditional PSCell Addition or Change.

51. The RAN node according to claim 48,
wherein the dual connectivity is a Multi-Radio Dual Connectivity (MR-DC).
